(19) United States
(12) Patent Application Publication
(10) Pub. No.: US 2023/0061881 A1
(43) Pub. Date: Mar. 2, 2023

(54) Measurement Device with Tunable Two-Dimensional Material for Environment Characterization

(71) Applicant: The United States of America, as represented by the Secretary of the Navy, San Diego, CA (US)

(72) Inventors: Nathan Scott Barnwell, San Diego, CA (US); Carlos Manuel Torres, JR., San Diego, CA (US); Burton H. Neuner, III, Escondido, CA (US)

(21) Appl. No.: 17/411,778

(22) Filed: Aug. 25, 2021

(51) Int. Cl. G01J 3/12; G01J 3/02

(52) U.S. Cl. CPC G01J 3/12; G01J 3/0297; G01J 2003/1269

(57) ABSTRACT

A measurement device characterizes an environment. The measurement device includes a transmitter and a receiver. The transmitter transmits a transmitted light. The transmitter includes an atomically two-dimensional material for emitting the transmitted light. The atomically two-dimensional material is tunable to select a predominate wavelength of the transmitted light within a tunable range of wavelengths. The receiver receives a received light, which is the transmitted light after encountering the environment. The receiver characterizes the environment from a measured change between the received light and the transmitted light.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, Calif., 92152; voice (619) 553-5118; ssc_pac_t2@navy.mil. Reference Navy Case Number 111798.

### BACKGROUND OF THE INVENTION

A challenge of spectroscopy over a wide spectrum is generating the entire electromagnetic spectrum. Typically, a source generates a wide spectrum of white light and a prism or grating provides wavelength dispersion before the detector. However, relative mechanical movement between the detector and the wavelength dispersion element is required. Alternatively, multiple sources and/or detectors are multiplexed to combine smaller measured spectrums into the full spectrum of interest.

### SUMMARY

A measurement device characterizes an environment. The measurement device includes a transmitter and a receiver. The transmitter transmits a transmitted light. The transmitter includes an atomically two-dimensional material for emitting the transmitted light. The atomically two-dimensional material is tunable to select a predominate wavelength of the transmitted light within a tunable range of wavelengths. The receiver receives a received light, which is the transmitted light after encountering the environment. The receiver characterizes the environment from a measured change between the received light and the transmitted light.

### BRIEF DESCRIPTION OF THE DRAWINGS

Throughout the several views, like elements are referenced using like references. The elements in the figures are not drawn to scale and some dimensions are exaggerated for clarity.

FIG. 1 is a block diagram of a measurement device for characterization of an environment.

### DETAILED DESCRIPTION OF EMBODIMENTS

The disclosed measurement device below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

An atomically two-dimensional material is tunable to select the predominate wavelength of emitted light. The inventors have discovered that this tuning enables a spectrometer without any wavelength dispersive element, and thereby eliminates mechanical movement of a wavelength dispersive element. Instead, an electrode voltage generates an electric field that electrically tunes the predominate wavelength of the emitted light. Furthermore, the atomically two-dimensional material is electrically tunable over a wide spectrum, providing measurement over a wide spectrum without multiplexing multiple sources and/or detectors.

Thus, the measurement device of embodiments of the invention have an atomically two-dimensional material emitting light with a predominate wavelength tunable over a wide spectrum, so that the measurement device has lower size, weight, and power (SWaP) than spectrometers covering a wide spectrum in the related art.

The inventors have discovered further improvement in SWaP in certain embodiments of the invention having a light detector that also includes an atomically two-dimensional material tunable to select the peak wavelength of the peak responsivity of the light detector. An electrode voltage generates an electric field that electrically tunes the peak wavelength of the peak responsivity of the atomically two-dimensional material. The atomically two-dimensional material of the light detector is the same or different from the two-dimensional material of the light source. Atomically two-dimensional materials for both the light source and light detector provide independent control of the predominate wavelength from the light source and the peak wavelength of the peak responsivity of the light detector. Such independent control enables detecting when emitted light of one wavelength causes detected light of lower or higher wavelengths, such as excited fluorescence or multiphoton absorbance. Other types of possible measurements include passively measuring background light, measuring optical transmissivity, measuring light scattering, measuring optically stimulated emission, and Raman spectroscopy.

Thus, electrode voltages control the tuning of both the predominate wavelength from the light source and the peak wavelength of the peak responsivity of the light detector in certain embodiments of the invention. Measurement is accomplished by analyzing the detection output from the light detector while varying both the predominate wavelength from the light source and the peak wavelength of the peak responsivity of the light detector.

Example applications of the low SWaP measurement device of embodiments of the invention include characterizing underwater environments, measuring contaminates like dust and smoke in the atmosphere, and measuring chemical concentrations in these and other environments. Embodiments of the invention have such an extremely low SWaP as to enable transport to comets, asteroids, planets, and other astronomical bodies for characterizing their environments.

U.S. Pat. No. 10,121,932 ““Tunable Graphene Light-Emitting Device” and U.S. Pat. No. 10,381,506 “Voltage-Tunable Wavelength-Agile 2D Material-Based Light-Emitting Transistors” are incorporated by reference. These patents provide further details on atomically two-dimensional materials, and, respectively, light emitting devices (2D-LED) and light emitting transistors (2D-LET) that include atomically two-dimensional materials. The 2D-LET is a particular type of 2D-LED.

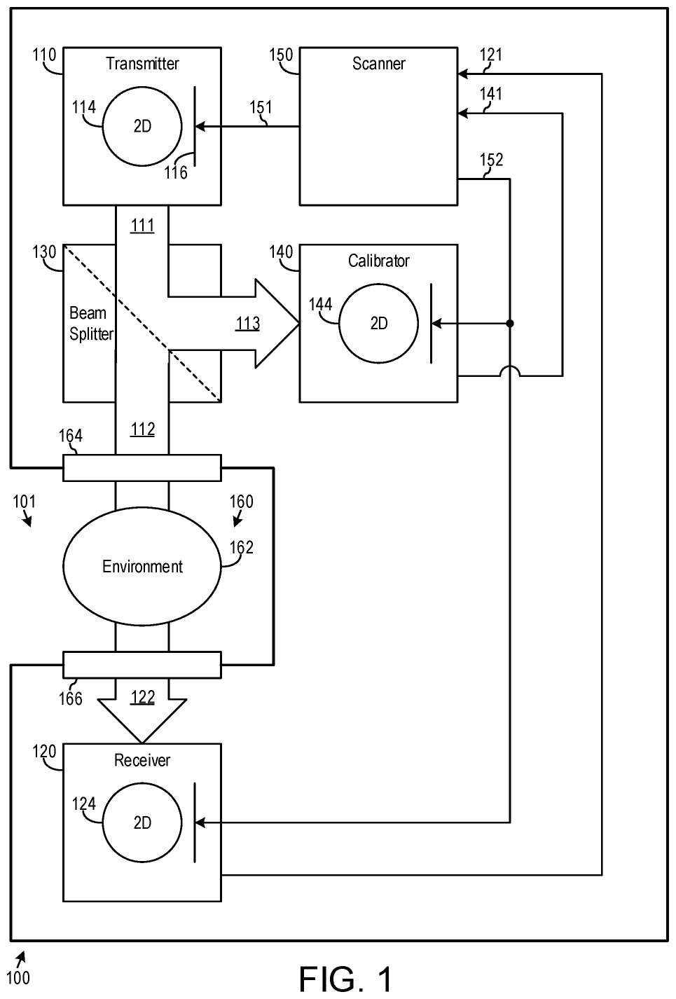

FIG. 1 is a block diagram of a measurement device 100 for characterization of an environment 101. The measurement device 100 includes a transmitter 110 and a receiver 120. The transmitter 110 transmits a transmitted light 112. The transmitter 110 includes an atomically two-dimensional material 114 for emitting the transmitted light 112. The atomically two-dimensional material 114 is tunable to select a predominate wavelength of the transmitted light 112 within a tunable range of wavelengths.

In one embodiment, the atomically two-dimensional material 114 is a two-dimensional molecule of graphene or black phosphorous, or a two-dimensional molecule of MoS₂, MoSe₂, WS₂, WSe₂, or other transition metal dichalcogenides. These molecules for atomically two-dimensional material 114 provide tunable direct bandgaps for incoherent light emission. More generally, the atomically two-dimensional material 114 is two or more layers of these molecules providing tunable indirect bandgaps. When the atomically two-dimensional material 114 is graphene, the transmitted light 112 has a tunable range from the visible to the mid-infrared with a full width at half maximum (FWHM) of approximately 200 nm. When the atomically two-dimensional material 114 is a transition metal dichalcogenide, the transmitted light 112 has a tunable range from the visible to the mid-infrared with a FWHM of approximately 25 nm, and the transmitted light 112 becomes coherent light with a sufficiently small area for emitting the transmitted light 112 from the atomically two-dimensional material 114.

Specifically, a molecule (single layer) of MoS₂ has a direct bandgap of 1.8 eV or 689 nm, a molecule of MoSe₂ has a direct bandgap of 1.57 eV or 792 nm, a molecule of WS₂ has a direct bandgap of 2.0 eV or 620 nm, and a molecule of WSe₂ has a direct bandgap of 1.63 eV or 759 nm. These bandgaps and associated wavelengths are each tunable from the visible to the mid-infrared.

The tunable range for the predominate wavelength of the transmitted light 112 emitted from the atomically two-dimensional material 114 is a continuously tunable range of the wavelengths. The continuously tunable range is continuously tunable from a shortest wavelength to a longest wavelength of the wavelengths in the tunable range, with the longest wavelength at least 20% longer than the shortest wavelength, or preferably at least twice the shortest wavelength. The transmitter 110 is configured to scan the predominate wavelength of the transmitted light 112 throughout the tunable range. The transmitter 110 is arranged to vary an electric field applied from an electrode 116 to the atomically two-dimensional material 114, and the electric field electrically tunes the predominate wavelength of the transmitted light 112 within the continuously tunable range. Thus, the atomically two-dimensional material 114 is electrically tunable without mechanical movement to select the predominate wavelength of the transmitted light 112 within the continuously tunable range.

The receiver 120 receives a received light 122, which is the transmitted light 112 after encountering and interacting with the environment 101. The receiver 120 characterizes the environment 101 from a measured change between the received light 122 and the transmitted light 112. The receiver 120 is configured to measure the measured change between the received light 122 and the transmitted light 112 throughout the tunable range.

The transmitted light 112 emitted from the atomically two-dimensional material 114 propagates through the environment 101 in an optical path from the atomically two-dimensional material 114 of the transmitter 110 to the receiver 120 to become the received light 122 at the receiver 120 without passing through a wavelength dispersive prism, wavelength dispersive grating, or other wavelength dispersive element along the optical path. Note that the beam splitter 130 discussed below includes a prism or prisms along the optical path in one embodiment; however, this prism or these prisms constitute a beam splitter and not wavelength dispersive elements.

In one embodiment, the transmitter 110 includes the atomically two-dimensional material 114 for emitting a combined light 111, which includes the transmitted light 112 and a reference light 113. In this embodiment, the transmitter 110 further includes a beam splitter 130 and a calibrator 140. The beam splitter 130 splits the combined light 111 into the transmitted light 112 and the reference light 113. For example, the beam splitter 130 is a partially silvered mirror disposed at an angle of 45 degrees to the beam of the combined light 111. The calibrator 140 measures characteristics of the reference light 113 from the beam splitter 130. The receiver 120 measures the characteristics of the received light 122. The measurement device 100 characterizes the environment 101 from the measured change, which is a difference between the characteristics measured in the received light 122 by the receiver 120 and the characteristics measured in the reference light 113 by the calibrator 140.

In one embodiment, the measurement device 100 further includes a scanner 150 that generates a first control signal 151 and a second control signal 152. In response to the first control signal 151, the transmitter 110 scans the predominate wavelength of the combined light 111 throughout the tunable range. In response to the second control signal 152, the calibrator 140 scans a peak wavelength of a peak responsivity of the calibrator 140 throughout the tunable range. Also in response to the second control signal 152, the receiver 120 scans a peak wavelength of a peak responsivity of the receiver 120 throughout the tunable range. The scanner 150 periodically varies the first control signal 151 for periodically varying an electric field applied from an electrode 116 to the atomically two-dimensional material 114 of the transmitter 110. The electric field electrically scans the predominate wavelength of the combined light 111 throughout a continuously tunable range of the wavelengths. The scanner 150 receives a first detection output 141 from the calibrator 140 and a second detection output 121 from the receiver 120. The scanner 150 determines the measured change between the received light 122 and the transmitted light 112 from the first and second detection outputs 141 and 121.

When the environment 101 is a vacuum, the measured change nominally measures no difference between the characteristics measured in the received light 122 by the receiver 120 and the characteristics measured in the reference light 113 by the calibrator 140. The characteristics including, for example, an observed intensity over the tunable range of the wavelengths.

To measure background light from the environment 101, the transmitter 110 is disabled so calibrator 140 receives no reference light 113, but the receiver 120 receives the received light 122 that includes the background light from the environment 101, such as bioluminescence. The measured change is the difference between the characteristics measured from the received light 122 by the receiver 120 and the characteristics, such as dark current, measured by the calibrator 140.

To measure transmittance of a sample 162 of the environment 101, the first and second control signals 151 and 152 are sweep together throughout the tunable range. During this sweep, the first control signal 151 sets the predominate wavelength of the transmitter 110, and the second control signal 152 synchronously sets the peak wavelength of the peak responsivity of the calibrator 140 and the receiver 120 to the predominate wavelength of the transmitter 110.

To measure stimulated emission of environment 101, the first control signal 151 sets the predominate wavelength of the transmitter 110 to a stimulation wavelength, and while the predominate wavelength is held constant or nearly constant at this stimulation wavelength, the second control signal 152 scans the peak wavelength of the peak responsivity of the calibrator 140 and the receiver 120 throughout the tunable range or a smaller range of interest. This is repeated for any additional stimulation wavelengths of interest, including stepping the stimulation wavelength from the transmitter 110 throughout the tunable range.

In one embodiment, the receiver 120 includes an instance of an atomically two-dimensional material 124, and the calibrator 140 includes a second instance of the atomically two-dimensional material 144. The atomically two-dimensional materials 124 and 144 provide high sensitivity from ultra-high surface to volume ratio, and provide light detection with a tunable range from the visible to the mid-infrared. The atomically two-dimensional material 124 of the receiver 120 is a same material as the atomically two-dimensional material 144 of the calibrator 140. However, atomically two-dimensional materials 124 and 144 are either the same as the atomically two-dimensional material 114 of the transmitter 110, or another atomically two-dimensional material. The first instance of the atomically two-dimensional material 124 of the receiver 120 is tunable to select a peak wavelength of a peak responsivity of the receiver 120 to the received light 122, and the second instance the atomically two-dimensional material 144 of the calibrator 140 is tunable to select the same peak wavelength of the same peak responsivity of the calibrator 140 to the reference light 113.

In a preferred embodiment, the atomically two-dimensional material 114 of the transmitter 110 is a two-dimensional molecule of graphene, and the first and second instances of the atomically two-dimensional material 124 and 144 of the receiver 120 and the calibrator 140 are a two-dimensional molecule selected from the group consisting of MoS₂, MoSe₂, WS₂, WSe₂, and other transition metal dichalcogenides.

Via the scanner 150 in one embodiment, the receiver 120 and the calibrator 140 are arranged to vary periodically respective electric fields applied in synchronization to the first and second instances of the atomically two-dimensional material 124 and 144 of the receiver 120 and the calibrator 140. The respective electric fields electrically scan, throughout the tunable range, the peak wavelength of the peak responsivity of the receiver 120 to the received light 122 and the peak wavelength of the peak responsivity of the calibrator 140 to the reference light 113.

For example, the scanner 150 raster scans the predominate wavelength of the combined light 111 and the peak wavelength of the peak responsivity for both the received light 122 and the reference light 113, with the raster scan relatively slowly scanning the predominate wavelength of the combined light 111 throughout the tunable range and relatively quickly scanning the peak wavelength of the peak responsivity for both the received light 122 and the reference light 113 throughout the tunable range.

In one embodiment, the transmitter 110 includes a two-dimensional light emitting transistor, which includes the atomically two-dimensional material 114 with a circular or rectangular active area for emitting the transmitted light 112, which passes through the environment 101 in a beam with a circular, elliptical, or rectangular cross-section to become the received light 122 at a corresponding circular, elliptical, or rectangular area of the receiver 120. It will be appreciated that the transmitted light 112 specularly or diffusively reflects from the environment 101 or scatters at acute or oblique angles from the environment 101 to the receiver 120 in other embodiments.

In one embodiment, the measurement device 100 further includes a receptacle 160 for holding a sample 162 of the environment 101. The transmitted light 112 passes through the sample 162 held in the receptacle 160 to become the received light 122 at the receiver 120. The receptacle 160 includes bandpass windows 164 and 166 that pass the wavelengths in the tunable range and isolate the environment 101 from the transmitter 110 and the receiver 120. The transmitted light 112 emitted from the atomically two-dimensional material 114 of the transmitter 110 propagates in sequence along an optical path from the atomically two-dimensional material 114, through the first bandpass window 164, through the sample 162 of the environment 101, through the second bandpass window 166, and to the receiver 120 to become the received light 122 at the receiver 120. It will be appreciated that sensitivity increases when mirrors direct the transmitted light 112 multiple times through the sample 162.

From the above description of Measurement Device with Tunable Two-Dimensional Material for Environment Characterization, it is manifest that various techniques may be used for implementing the concepts of measurement device 100 without departing from the scope of the claims. The described embodiments are to be considered in all respects as illustrative and not restrictive. The apparatus disclosed herein may be practiced in the absence of any element that is not specifically claimed and/or disclosed herein. It should also be understood that measurement device 100 is not limited to the particular embodiments described herein, but is capable of many embodiments without departing from the scope of the claims.

We claim:

1. A measurement device for characterization of an environment, comprising:
a transmitter for transmitting a transmitted light, the transmitter including an atomically two-dimensional material for emitting the transmitted light, the atomically two-dimensional material tunable to select a predominate wavelength of the transmitted light within a tunable range of wavelengths; and
a receiver for receiving a received light, which is the transmitted light after encountering the environment, the receiver for characterizing the environment from a measured change between the received light and the transmitted light.

2. The measurement device of claim 1, wherein the atomically two-dimensional material is a two-dimensional molecule selected from the group consisting of graphene, black phosphorous, and MoS₂, MoSe₂, WS₂, WSe₂, and other transition metal dichalcogenides.

3. The measurement device of claim 1, wherein the transmitted light emitted from the atomically two-dimensional material propagates through the environment in an optical path from the atomically two-dimensional material of the transmitter to the receiver to become the received light at the receiver without passing through a wavelength dispersive prism, wavelength dispersive grating, or other wavelength dispersive element along the optical path.

4. The measurement device of claim 1, wherein the tunable range for the predominate wavelength of the transmitted light emitted from the atomically two-dimensional material is a continuously tunable range of the wavelengths.

5. The measurement device of claim 4, wherein the continuously tunable range of the wavelengths is continuously tunable from a shortest wavelength to a longest wavelength of the wavelengths in the tunable range, with the longest wavelength at least 20% longer than the shortest wavelength.

6. The measurement device of claim 4, wherein the continuously tunable range of the wavelengths is continuously tunable from a shortest wavelength to a longest wavelength of the wavelengths in the tunable range, with the longest wavelength at least twice the shortest wavelength.

7. The measurement device of claim 4, wherein the atomically two-dimensional material is electrically tunable without mechanical movement to select the predominate wavelength of the transmitted light within the continuously tunable range.

8. The measurement device of claim 4, wherein the transmitter is arranged to vary an electric field applied to the atomically two-dimensional material, the electric field electrically tuning the predominate wavelength of the transmitted light within the continuously tunable range.

9. The measurement device of claim 1, wherein:
the transmitter is configured to scan the predominate wavelength of the transmitted light throughout the tunable range; and
the receiver is configured to measure the measured change between the received light and the transmitted light throughout the tunable range.

10. The measurement device of claim 1, wherein the transmitter includes:
the atomically two-dimensional material for emitting a combined light, which includes the transmitted light and a reference light;
a beam splitter that splits the combined light into the transmitted light and the reference light; and
a calibrator for measuring a plurality of characteristics of the reference light from the beam splitter.

11. The measurement device of claim 10, wherein the receiver is for measuring the characteristics of the received light and for characterizing the environment from the measured change, which is a difference between the characteristics measured in the received light by the receiver and the characteristics measured in the reference light by the calibrator.

12. The measurement device of claim 11, further comprising a scanner for generating a first and a second control signal wherein:
in response to the first control signal, the transmitter is configured to scan the predominate wavelength of the combined light throughout the tunable range;
in response to the second control signal, the calibrator is configured to scan a peak wavelength of a peak responsivity of the calibrator throughout the tunable range; and
in response to the second control signal, the receiver is also configured to scan the peak wavelength of the peak responsivity of the receiver throughout the tunable range.

13. The measurement device of claim 12, wherein the scanner is arranged to periodically vary the first control signal for periodically varying an electric field applied to the atomically two-dimensional material of the transmitter, the electric field electrically scanning the predominate wavelength of the combined light throughout the tunable range, which is a continuously tunable range of the wavelengths.

14. The measurement device of claim 12, wherein the scanner is arranged to receive a first detection output from the calibrator and a second detection output from the receiver, and the scanner is configured to determine the measured change between the received light and the transmitted light from the first and second detection outputs.

15. The measurement device of claim 11, wherein:
the receiver includes a first instance of an instantiated two-dimensional material, which is the atomically two-dimensional material of the transmitter or another atomically two-dimensional material, the first instance tunable to select a peak wavelength of a peak responsivity of the receiver to the received light; and
the calibrator includes a second instance of the instantiated two-dimensional material, the second instance tunable to select the peak wavelength of the peak responsivity of the calibrator to the reference light.

16. The measurement device of claim 15, wherein the receiver and the calibrator are arranged to periodically vary respective electric fields applied in synchronization to the first and second instances of the instantiated two-dimensional material, the respective electric fields electrically scanning, throughout the tunable range, the peak wavelength of the peak responsivity of the receiver to the received light and the peak wavelength of the peak responsivity of the calibrator to the reference light.

17. The measurement device of claim 16, wherein the atomically two-dimensional material of the transmitter is a two-dimensional molecule of graphene, and the instantiated two-dimensional material of the first and second instances is a two-dimensional molecule selected from the group consisting of MoS₂, MoSe₂, WS₂, WSe₂, and other transition metal dichalcogenides.

18. The measurement device of claim 1, wherein the transmitter includes a two-dimensional light emitting device, which includes the atomically two-dimensional material with an active area for emitting the transmitted light, which passes through the environment in a beam to become the received light at a corresponding active area of the receiver.

19. The measurement device of claim 1, further comprising a receptacle for holding a sample of the environment, the transmitted light passing through the sample held in the receptacle to become the received light at the receiver.

20. The measurement device of claim 19, wherein the receptacle includes a first and second bandpass window that pass the wavelengths in the tunable range and isolate the environment from the transmitter and the receiver, and the transmitted light emitted from the atomically two-dimensional material of the transmitter propagates in sequence from the atomically two-dimensional material, through the first bandpass window, through the sample of the environment, through the second bandpass window, and to the receiver to become the received light at the receiver.
